(19) United States
(12) Patent Application Publication
(10) Pub. No.: US 2025/0146903 A1
(43) Pub. Date: May 8, 2025

(54) Optical Time-Domain Reflectometry System and Method

(71) Applicant: II-VI Photonics, Inc., Fuzhou (CN)

(72) Inventors: Dong Li, Shanghai (CN); Binbing Liu, Shanghai (CN)

(21) Appl. No.: 18/510,708

(22) Filed: Nov. 16, 2023

(30) Foreign Application Priority Data
Nov. 2, 2023 (CN) 202311444827.7

(51) Int. Cl. G01M 11/00

(52) U.S. Cl. CPC G01M 11/3145

(57) ABSTRACT

In a system and method of Optical Time-Domain Reflectometry a laser source outputs a laser pulse to an optical fiber. A processor samples a backscatter signal generated by the optical fiber in response to the laser pulse. Upon determining from the samples that the backscatter signal has an amplitude whereupon an element of a receiver is in a saturated operating state, the processor decreases the amplitude of subsequent samples of the backscatter signal output by the receiver to within an unsaturated operating state of the element of the receiver. Thereafter, upon determining from subsequent samples of the backscatter signal that the backscatter signal does not have (or no longer has) an amplitude whereupon the element of the receiver would be in the saturated state, the processor increases the amplitude of the samples of the backscatter signal output by the receiver for sampling by the processor.

### CROSS-REFERENCE TO RELATED APPLICATION

This application claims priority to Chinese Patent Application No. 202311444827.7 filed Nov. 2, 2023, the disclosure of which is hereby incorporated by reference in its entirety.

### BACKGROUND

### 1) Field

The present disclosure relates to a system and method for Optical Time-Domain Reflectometry.

### 2) Background

Optical Time-Domain Reflectometry is a precise photoelectric integrated instrument which uses backscatter signal generated by Rayleigh scattering and Fresnel reflection when light is transmitted in optical fibers. It is widely used in the detection, maintenance and construction of optical cable lines. The optical fiber length, optical fiber transmission attenuation, joint attenuation and fault location can be measured. It has the advantages of short test time, fast test speed and high test accuracy.

With the development of Optical Time-Domain Reflectometry to higher dynamic range and larger detection distance, a high-power pulsed laser is widely used. In the process of transmission, the intensity of light generated by Fresnel reflection is about 30 dB higher than that of Rayleigh scattering, and the reflected echo signal of high-power pulsed laser will cause pulse saturation of photodetector. It takes time for the photodetector to return from the saturated state to the normal state and respond to the light signal again. The saturation duration of the detector increases with the increase of the incident pulse power. During the recovery of the detector, the Optical Time-Domain Reflectometer (OTDR) cannot accurately detect the optical signal, and a blind spot appears in the test results. In addition, when the input signal is large enough, the level of the detector circuit unit and the analog/digital converter (ADC) will become over-saturated, resulting in a low signal-to-noise ratio of the circuit and an overshoot of the step signal response, resulting in a lot of nonlinear signals. Accordingly, there is a significant signal distortion on the OTDR curve. These limit the measurement range of the OTDR.

In order to improve the measurement accuracy, one conventional method is to subdivide the resistance value of the transconductance resistor. The photocurrent output of the photodetector is converted from the transconductance resistance into a single terminal voltage signal. Different transconductance gains can be selected according to different photocurrent sizes. However, because the light intensity generated by Fresnel reflection in the transmission process is about 30 dB higher than that of Rayleigh scattering, the input of the input ADC is easy to saturate. And too much gain will also cause the measurement time to be too long.

In order to improve the measurement accuracy, another method adds a dead zone eliminator (also known as launch fiber) between the OTDR and the measured fiber to avoid the OTDR optical outlet dead zone, and then measure the joint loss and connector loss of the measured fiber, so the length of the launch fiber should be greater than the attenuation dead zone. The disadvantage is that the length of the launch fiber will vary with the width of the light pulse and the dissipation time of the photodetector photogenerated carrier. If the length of the launch fiber is not appropriate, the test results will be inaccurate and the measurement range will be affected. In addition, the launch fiber can only solve the problem of dead zone at the OTDR output port, but not at other locations.

### SUMMARY

Disclosed is an Optical Time-Domain Reflectometry method comprising: (a) outputting, by a laser source of an Optical Time-Domain Reflectometer (OTDR), to an optical fiber, a laser pulse; (b) acquiring, by a processor of the OTDR from a receiver of the OTDR, samples of a backscatter signal generated by the optical fiber in response to the laser pulse of step (a); (c) determining, by the processor, from one or more values of the samples sampled in step (b) that at least one element of the receiver is in a saturated operating state; (d) in response to step (c), controlling, by the processor, the receiver to decrease values of the samples of the backscatter signal sampled by the processor to within an unsaturated operating state of the at least one element of the receiver; (e) determining, by the processor, from one or more values of samples of the backscatter signal sampled after step (d) that the at least one element of the receiver would not be operating in the saturated operating state if the values of samples of the backscatter signal sampled by the processor were increased; and (f) in response to step (e), controlling, by the processor, the receiver to increase the values of the samples of the backscatter signal sampled by the processor.

Also disclosed is an Optical Time-Domain Reflectometer (OTDR) comprising: a laser source operative, under the control of a processor via a pulse generator, for outputting a laser pulse to an optical fiber; a receiver for receiving a backscatter signal generated by the optical fiber in response to the laser pulse output to the optical fiber, wherein the processor is programmed or configured to: (a) determine from one or more values of samples of the received backscatter signal that at least one element of the receiver is operating in a saturated operating state; (b) in response to the determining in step (a), control the receiver to decrease one or more values of samples of the received backscatter signal sampled after step (a), whereupon the at least one element of the receiver is operating in an unsaturated operating state; (c) determine from one or more values of samples of the received backscatter signal sampled after step (b) that the at least one element of the receiver would not be operating in the saturated operating state if the values of samples of the backscatter signal were increased; and (d) in response to step (c), control the receiver to increase one or more values of samples of the backscatter signal sampled after step (c).

Finally, disclosed is an Optical Time-Domain Reflectometer (OTDR) comprising: means for outputting a laser pulse to an optical fiber; means for receiving an optical backscatter signal generated by the optical fiber in response to the laser pulse output to the optical fiber; means for determining from values of samples of the received optical backscatter signal that at least one element of the means for receiving is operating in a saturated state; and means for controlling the means for receiving to decrease the values of the samples of the optical backscatter signal received by the means for determining such that the at least one element of the means for receiving is operating in an unsaturated state, wherein: the means for determining determines from the values of the samples of the optical backscatter signal acquired after decreasing the values of the samples that the at least one element of the means for receiving would not be operating in a saturated state if the values of samples were increased; and the means for controlling controls the means for receiving to increase the values of the samples of the optical backscatter signal acquired after the means for determining determines that the at least one element of the means for receiving would not be operating in a saturated state if the values of samples were increased.

### BRIEF DESCRIPTION OF THE DRAWINGS

FIG. 1 is a schematic of an example OTDR comprising a transimpedance amplifier (TIA) for performing dynamic transresistance switching on a backscatter signal generated by Rayleigh scattering and Fresnel reflection in accordance with the principles of the present disclosure;

FIG. 2 is a schematic of an example OTDR comprising an avalanche photodiode (APD) for performing dynamic gain switching on a backscatter signal generated by Rayleigh scattering and Fresnel reflection in accordance with the principles of the present disclosure;

FIG. 3 is a schematic of an example OTDR comprising a variable optical attenuator (VOA) for performing dynamic power adjustment on a backscatter signal generated by Rayleigh scattering and Fresnel reflection in accordance with the principles of the present disclosure; and

FIG. 4 is a method in accordance with the principles of the present disclosure.

### DETAILED DESCRIPTION

As used herein, spatial or directional terms, such as “left”, “right”, “inner”, “outer”. “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure.

At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

Various non-limiting examples will now be described with reference to the accompanying figures where like reference numbers correspond to like or functionally equivalent elements.

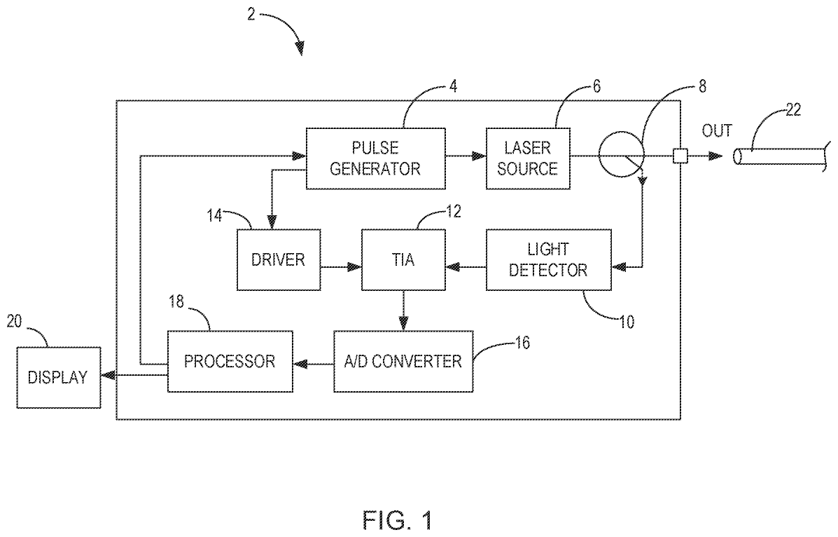

Functional block diagrams of different example OTDRs in accordance with the principles of the present disclosure are shown in FIGS. 1, 2 and 3, wherein under the control of a processor, a pulse driven laser generates a laser pulse having specific wavelength, wherein the width of the laser pulse may be adjustable between 10 ns-20000 ns. As the laser pulse propagates along the fiber under test, light transmitted in the fiber, due to Rayleigh scattering and Fresnel reflection, in response to the laser pulse will be returned to photodetector of the OTDR through the circulator. Herein, Rayleigh scattering and Fresnel reflection may be collectively referred to in this disclosure as a “backscatter signal” or an “optical backscatter signal”. The photodetector converts the backscatter signal into a weak electrical signal, which is then sent to the processor for sampling after amplification and analog-to-digital conversion. By detecting the intensity of the returned light in the backscatter signal and the time it takes for the returned light to return to the photodetector, the relative loss information of the measured light path in the fiber under test may be displayed, e.g., on a visual display or output on physical media, such as paper, as a coordinate graph, whereupon the loss and fault location of the entire the fiber under test can be determined.

In an example, the backscatter signal may, after generation of the laser pulse, be sampled by the processor for a predetermined time corresponding to a length of the fiber under test and/or until the processor determines from the samples that an end of the fiber under test has been sampled. However, this is not to be construed in a limiting sense.

With reference to FIG. 1, an example OTDR 2 for performing dynamic transresistance switching in accordance with the principles of the present disclosure comprises a pulse generator 4, a laser source 6, an optical circulator 8, a light detector 10, e.g., a photodiode or a photoconductor, a transimpedance amplifier (TIA) 12, a driver 14, an analog-to-digital converter (ADC) 16, and a processor 18, e.g., a microprocessor or programmable gate array. The processor 18 may be connected to a display 20, e.g., an LCD or OLED display, for displaying the coordinate graph, or a printer which prints the coordinate graph on physical media such a paper.

Under the control of the processor 18 the pulse generator 4 outputs an electrical pulse which drives the laser source 6 to generate a laser pulse of a specific wavelength and width. When the laser pulse is propagated along the fiber under test 22 via the optical circulator 8, the light transmitted in the fiber under test 22 will be returned to the light detector 10 due to Rayleigh scattering and Fresnel reflection along the fiber under test 22 via the optical circulator 8. The light detector 10 converts the received backscatter signal into an electrical signal, which may be amplified by the TIA 12 and converted by the ADC 16 into digital signals corresponding to the backscatter signal before being sent to the processor 18 for processing, storage and output on the display 20 as the coordinate graph.

When the laser pulse is generated, the strongly reflected signal generated by Fresnel reflection may have an amplitude that will saturate the light detector 10 and/or the ADC 16. After detecting this strongly reflected signal via samples of the digital signals output by the ADC 16 corresponding to this strongly reflected signal, the processor 18 quickly (e.g., within a few nanoseconds (ns) or milliseconds (ms)) controls the pulse generator 4 to select a transresistance unit of the TIA 12 having a lower gain via the driver 14, whereupon the amplitude of the signal from the TIA 12 sampled by the ADC 16 is reduced to within the sampling range of the ADC 16. After detecting via samples of the digital signals from the ADC 16 that the strongly reflected signal is no longer present in the received backscatter signal, the processor 18 quickly controls the pulse generator 4, via the driver 14, to select (or return to) a transresistance unit of the TIA 12 having a higher gain. In an example, the selection of transresistance units having lower and higher gains may be repeated, as necessary, one or more times during sampling of the backscatter signal corresponding to the entire length of the fiber under test.

In an example, the transresistance unit having the higher gain may be the same (or different) transresistance unit that was in use prior to the selection of the transresistance unit having a lower gain. However, this is not to be construed in a limiting sense. In an example, the light detector 10, the TIA 12 and the ADC 16 may comprise elements of a receiver of the OTDR 2 of FIG. 1. Since TIA's are known in the art, details regarding the TIA 12 will not be described herein for the purpose of simplicity.

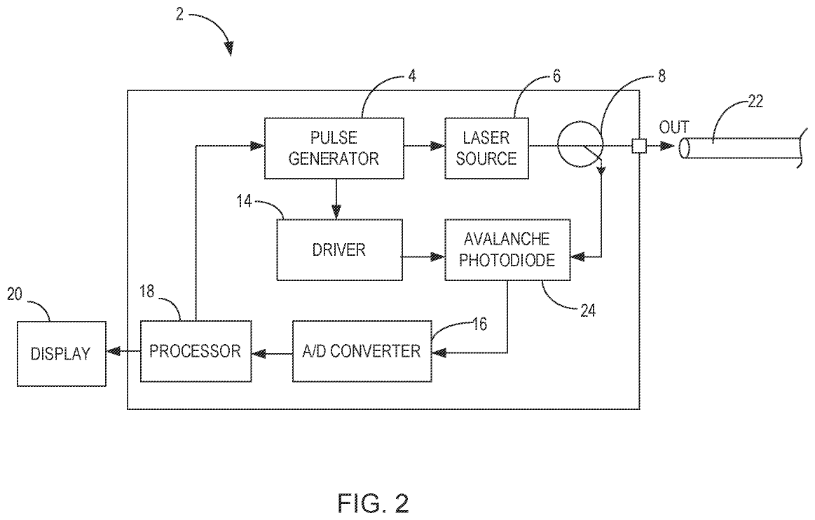

With reference to FIG. 2, another example OTDR 2 for performing dynamic gain switching in accordance with the principles of the present disclosure is, with the following exception, similar to the OTDR 2 shown in FIG. 1. The exception is OTDR 2 shown in FIG. 2 includes an avalanche photodiode 24 in replacement of the light detector 10 and TIA 12 of the OTDR 2 shown in FIG. 1.

Under the control of the processor 18 the pulse generator 4 outputs an electrical pulse which drives the laser source 6 to generate a laser pulse of a specific wavelength and width. When the laser pulse is propagated along the fiber under test 22 via the optical circulator 8, the light transmitted in the fiber under test 22 will be returned to the avalanche photodiode 24 due to Rayleigh scattering and Fresnel reflection along the fiber under test 22 via the optic circulator 8. The avalanche photodiode 24 converts the received backscatter signal into an electrical signal, which may be amplified and converted by the ADC 16 into digital signals corresponding to the backscatter signal before being sent to the processor 18 for processing and storage.

When the laser pulse is generated, the strongly reflected signal generated by Fresnel reflection may have an amplitude that will saturate the avalanche photodiode 24 and the ADC 16. After detecting this strongly reflected signal via samples of the digital signals output by the ADC 16 corresponding to this strongly reflected signal, the processor 18 quickly controls the pulse generator 4 to decrease or lower a gain of the avalanche photodiode 24 via the driver 14, whereupon the amplitude of the reflected signal sampled by the ADC 16 is reduced to within the sampling range of the ADC 16. After detecting via samples of the digital signals from the ADC 16 that the strongly reflected signal is no longer present in the received backscatter signal, the processor 18, via the driver 14, quickly controls the pulse generator 4 to increase the gain of the avalanche photodiode 24. In an example, the lowering and increasing of the gain of the avalanche photodiode 24 may be repeated, as necessary, one or more times during sampling of the backscatter signal corresponding to the entire length of the fiber under test.

In an example, the increased gain of the avalanche photodiode 24 may be the same (or different) than the gain of the avalanche photodiode 24 prior to being decreased or lowered. However, this is not to be construed in a limiting sense. In an example, the avalanche photodiode 24 and the ADC 16 may comprise elements of a receiver of the OTDR 2 of FIG. 2. Since avalanche photodiode's are known in the art, details regarding the avalanche photodiode 24 will not be described herein for the purpose of simplicity.

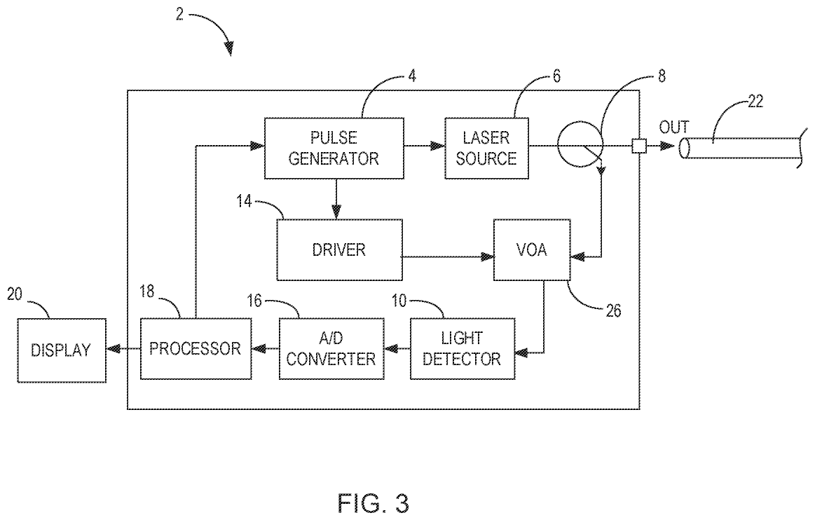

With reference to FIG. 3, another example OTDR 2 for performing dynamic power adjustment on a backscatter signal in accordance with the principles of the present disclosure is, with the following exception, similar to the OTDR 2 shown in FIG. 2. The exception is OTDR 2 shown in FIG. 3 includes an variable optical attenuator (VOA) 26 in series with a light detector 10 in replacement of the avalanche photodiode 24 of the OTDR 2 shown in FIG. 2.

Under the control of the processor 18 the pulse generator 4 outputs an electrical pulse which drives the laser source 6 to generate a laser pulse of a specific wavelength and width. When the laser pulse is propagated along the fiber under test 22 via the optical circulator 8, the light transmitted in the fiber under test 22 will be returned to the VOA 26 due to Rayleigh scattering and Fresnel reflection along the fiber under test 22 via the optic circulator 8. The light detector 10 and the VOA 26 convert the received backscatter signal into an electrical signal, which may be amplified and converted by the ADC 16 into digital signals corresponding to the backscatter signal before being sent to the processor 18 for processing and storage.

When the laser pulse is generated, the strongly reflected signal generated by Fresnel reflection has an amplitude that will saturate the light detector 10 and the ADC 16. After detecting this strongly reflected signal via samples of the digital signals output by the ADC 16 corresponding to this strongly reflected signal, the processor 18, via the driver 14, quickly controls the pulse generator 4 to increase a loss of the of the VOA 26 whereupon the amplitude of the reflected signal sampled by the ADC 16 is reduced to within the sampling range of the ADC 16. After detecting via samples of the digital signals from the ADC 16 that the strongly reflected signal is no longer present in the received backscatter signal, the processor 18, via the driver 14, quickly controls the pulse generator 4 to select (or return to) a decreased loss of the VOA 26. In an example, increasing and decreasing the loss of the VOA 25 may be repeated, as necessary, one or times during sampling of the backscatter signal corresponding to the entire length of the fiber under test.

In an example, the decreased loss of the VOA 26 may be the same (or different) than the loss of the VOA 26 prior to being increased. However, this is not to be construed in a limiting sense. In an example, the VOA 26, the light detector 10, and the ADC 16 may comprise elements of a receiver of the OTDR 2 of FIG. 3. Since VOA's are known in the art, details regarding the VOA 26 will not be described herein for the purpose of simplicity.

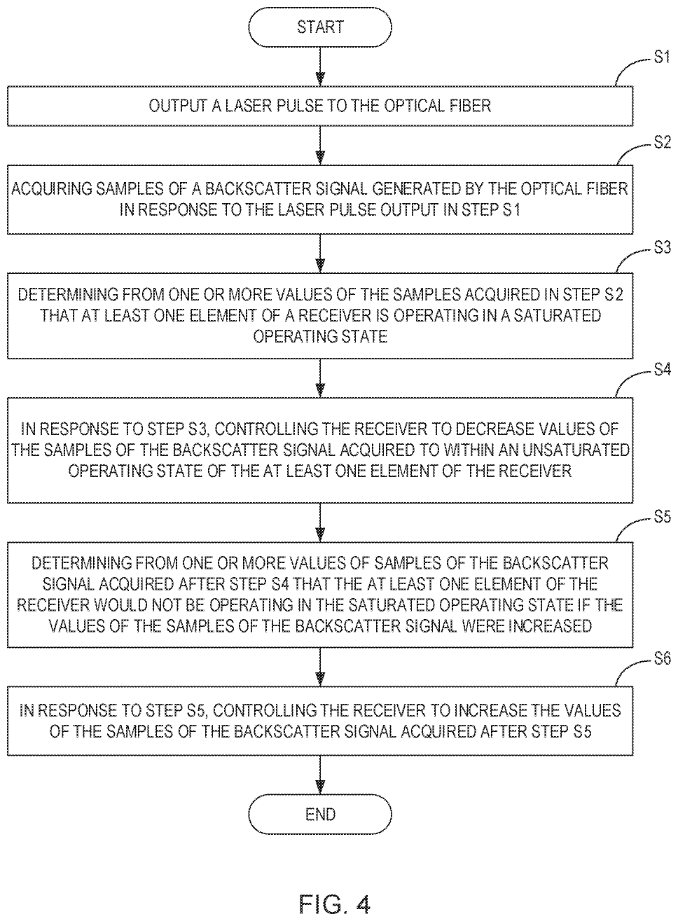

With reference to FIG. 4 and with continuing reference to all previous figures, a method in accordance with the principles of the present disclosure may include a step S1 wherein the laser source 6 of the OTDR 2 outputs a laser pulse to the optical fiber 22. In step S2, the processor 18 acquires samples of a backscatter signal generated by the optical fiber 22 in response to the laser pulse in step S1.

In step S3, the processor 18 determines from one or more values of the samples acquired in step S2 that at least one element of the receiver is operating in a saturated operating state. In step S4, in response to step S3, the processor 18 controls the receiver to decrease values of the samples of the backscatter signal acquired by the processor to within an unsaturated operating state of the at least one element of the receiver.

In step S5, the processor determines from one or more values of samples of the backscatter signal acquired after step S4 that the at least one element of the receiver would not be operating in the saturated operating state if the values of the samples of the backscatter signal were increased. Finally, in step S6, in response to step S5, the processor controls the receiver to increase the values of the samples of the backscatter signal acquired by the processor after step S5.

In an example, this method may be repeated, as necessary, one or times during sampling of the backscatter signal corresponding to the entire length of the fiber under test.

In an example, the values of the samples of the backscatter signal acquired in steps S3 and S6 may be the same, in particular, when the amplitude of the laser pulse is the same when steps S3 and S6 are performed.

Other non-limiting examples or aspects of this disclosure are set forth in the following illustrative and exemplary numbered clauses:

Clause 1: An Optical Time-Domain Reflectometry method comprises: (a) outputting, by a laser source of an Optical Time-Domain Reflectometer (OTDR), to an optical fiber, a laser pulse; (b) acquiring, by a processor of the OTDR from a receiver of the OTDR, samples of a backscatter signal generated by the optical fiber in response to the laser pulse of step (a); (c) determining, by the processor, from one or more values of the samples sampled in step (b) that at least one element of the receiver is in a saturated operating state; (d) in response to step (c), controlling, by the processor, the receiver to decrease values of the samples of the backscatter signal sampled by the processor to within an unsaturated operating state of the at least one element of the receiver; (e) determining, by the processor, from one or more values of samples of the backscatter signal sampled after step (d) that the at least one element of the receiver would not be operating in the saturated operating state if the values of samples of the backscatter signal sampled by the processor were increased; and (f) in response to step (c), controlling, by the processor, the receiver to increase the values of the samples of the backscatter signal sampled by the processor.

Clause 2: The method of clause 1, wherein: elements of the receiver may include a light detector and a transimpedance amplifier (TIA); step (d) may include selecting a transresistance unit of the TIA having a lower gain; and step (f) may include selecting a transresistance unit of the TIA having a higher gain.

Clause 3: The method of clause 2, wherein the higher gain of the TIA in step (f) may be the same as the gain of the TIA in step (c).

Clause 4: The method of clause 2, wherein the higher gain of the TIA in step (f) may be different than the gain of the TIA in step (c).

Clause 5: The method of clause 1, wherein: the at least one element of the receiver may include an avalanche photodiode; step (d) may include decreasing a gain of the avalanche photodiode; and step (f) may include increasing a gain of the avalanche photodiode.

Clause 6: The method of clause 5, wherein the higher gain of the avalanche photodiode in step (f) may be the same as the gain of the avalanche photodiode in step (c).

Clause 7: The method of clause 5, wherein the higher gain of the avalanche photodiode in step (f) may be different than the gain of the avalanche photodiode in step (c).

Clause 8: The method of clause 1, wherein: elements of the receiver may include a variable optical attenuator (VOA) and a light detector; step (d) may include increasing a loss of the VOA; and step (f) may include decreasing a loss of the VOA.

Clause 9: The method of clause 8, wherein the decreased loss of the VOA in step (f) may be the same as the loss of the VOA in step (c).

Clause 10: The method of clause 8, wherein the decreased loss of the VOA in step (f) may be different than the loss of the VOA in step (c).

Clause 11: The method of any one of clauses 1-10, wherein the one or more values sampled in step (e) may be the same as the one or more values sampled in step (b).

Clause 12: The method of any one of clauses 1-10, wherein the one or more values sampled in step (e) may be different than the one or more values sampled in step (b).

Clause 13: An Optical Time-Domain Reflectometer (OTDR) comprising: a laser source operative, under the control of a processor via a pulse generator, for outputting a laser pulse to an optical fiber; a receiver for receiving a backscatter signal generated by the optical fiber in response to the laser pulse output to the optical fiber, wherein the processor is programmed or configured to: (a) determine from one or more values of samples of the received backscatter signal that at least one element of the receiver is operating in a saturated operating state; (b) in response to the determining in step (a), control the receiver to decrease one or more values of samples of the received backscatter signal sampled after step (a), whereupon the at least one element of the receiver is operating in an unsaturated operating state; (c) determine from one or more values of samples of the received backscatter signal sampled after step (b) that the at least one element of the receiver would not be operating in the saturated operating state if the values of samples of the backscatter signal were increased; and (d) in response to step (c), control the receiver to increase one or more values of samples of the backscatter signal sampled after step (c).

Clause 14: The OTDR of clause 13, wherein: elements of the receiver may include a light detector and a transimpedance amplifier (TIA); step (b) may include selecting a transresistance unit of the TIA having a lower gain; and step (d) may include selecting a transresistance unit of the TIA having a higher gain.

Clause 15: The OTDR of clause 13, wherein: the at least one element of the receiver may include an avalanche photodiode; step (b) may include decreasing a gain of the avalanche photodiode; and step (d) may include a gain of the avalanche photodiode.

Clause 16: The OTDR of clause 13, wherein: elements of the receiver may include a variable optical attenuator (VOA) and a light detector; step (b) may include increasing a loss of the VOA; and step (d) may include decreasing a loss of the VOA

Clause 17: An Optical Time-Domain Reflectometer (OTDR) comprising: means for outputting a laser pulse to an optical fiber; means for receiving an optical backscatter signal generated by the optical fiber in response to the laser pulse output to the optical fiber; means for determining from values of samples of the received optical backscatter signal that at least one element of the means for receiving is operating in a saturated state; and means for controlling the means for receiving to decrease the values of the samples of the optical backscatter signal received by the means for determining such that the at least one element of the means for receiving is operating in an unsaturated state, wherein: the means for determining determines from the values of the samples of the optical backscatter signal acquired after decreasing the values of the samples that the at least one element of the means for receiving would not be operating in a saturated state if the values of samples were increased; and the means for controlling controls the means for receiving to increase the values of the samples of the optical backscatter signal acquired after the means for determining determines that the at least one element of the means for receiving would not be operating in a saturated state if the values of samples were increased.

Clause 18: The OTDR of clause 17, comprising at least one of the following: the means for outputting the laser pulse to the optical fiber may include a laser source; the means for receiving may include one of a transimpedance amplifier (TIA), a variable optical attenuator (VOA), and an avalanche photodiode; the means for determining may include a processor; and the means for controlling may include the processor.

Clause 19: The OTDR of clause 18, wherein the means for receiving may further include one of the following: a light detector for converting the received optical backscatter signal into a first electrical signal that the TIA converts to a second electrical signal, having an amplitude that is under the control of the processor, that an analog-to-digital converter (ADC) converts into the samples of the received optical backscatter signal, wherein the samples of the received optical backscatter signal are digitized samples; a light detector for converting an optical signal output by the VOA in response to the received optical backscatter signal into an electrical signal that an analog-to-digital converter (ADC) converts into the samples of the received optical backscatter signal, wherein the samples of the received optical backscatter signal are digitized samples; and an analog-to-digital converter (ADC), wherein the avalanche photodiode converts the received optical backscatter signal into an electrical signal that the ADC converts into the samples of the received optical backscatter signal, wherein the samples of the received optical backscatter signal are digitized samples.

Clause 20: The method of any one of clauses 1-12, wherein the samples in steps (b) and (e) may be digital signals output to the processor by an analog-to-digital converter of the receiver of the OTDR.

Clause 21: The OTDR of any one of clauses 13-16, wherein the samples in steps (a) and (c) may be digital signals output to the processor by an analog-to-digital converter of the receiver of the OTDR.

Clause 22: The OTDR of any one of clauses 17-19, wherein the at least one element of the means for receiving may be an analog-to-digital converter (ADC).

Although this disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. An Optical Time-Domain Reflectometry method comprising:
(a) outputting, by a laser source of an Optical Time-Domain Reflectometer (OTDR), to an optical fiber, a laser pulse;
(b) acquiring, by a processor of the OTDR from a receiver of the OTDR, samples of a backscatter signal generated by the optical fiber in response to the laser pulse of step (a);
(c) determining, by the processor, from one or more values of the samples sampled in step (b) that at least one element of the receiver is in a saturated operating state;
(d) in response to step (c), controlling, by the processor, the receiver to decrease values of the samples of the backscatter signal sampled by the processor to within an unsaturated operating state of the at least one element of the receiver;
(e) determining, by the processor, from one or more values of samples of the backscatter signal sampled after step (d) that the at least one element of the receiver would not be operating in the saturated operating state if the values of samples of the backscatter signal sampled by the processor were increased; and
(f) in response to step (e), controlling, by the processor, the receiver to increase the values of the samples of the backscatter signal sampled by the processor.

2. The method of claim 1, wherein:
elements of the receiver include a light detector and a transimpedance amplifier (TIA);
step (d) includes selecting a transresistance unit of the TIA having a lower gain; and
step (f) includes selecting a transresistance unit of the TIA having a higher gain.

3. The method of claim 2, wherein the higher gain of the TIA in step (f) is the same as the gain of the TIA in step (c).

4. The method of claim 2, wherein the higher gain of the TIA in step (f) is different than the gain of the TIA in step (c).

5. The method of claim 1, wherein:
the at least one element of the receiver includes an avalanche photodiode;
step (d) includes decreasing a gain of the avalanche photodiode; and
step (f) includes increasing a gain of the avalanche photodiode.

6. The method of claim 5, wherein the increased gain of the avalanche photodiode in step (f) is the same as the gain of the avalanche photodiode in step (c).

7. The method of claim 5, wherein the increased gain of the avalanche photodiode in step (f) is different than the gain of the avalanche photodiode in step (c).

8. The method of claim 1, wherein:
elements of the receiver include a variable optical attenuator (VOA) and a light detector;
step (d) includes increasing a loss of the VOA; and
step (f) includes decreasing a loss of the VOA.

9. The method of claim 8, wherein the decreased loss of the VOA in step (f) is the same as the loss of the VOA in step (c).

10. The method of claim 8, wherein the decreased loss of the VOA in step (f) is different than the loss of the VOA in step (c).

11. The method of claim 1, wherein the one or more values sampled in step (e) is the same as the one or more values sampled in step (b).

12. The method of claim 1, wherein the one or more values sampled in step (e) is different than the one or more values sampled in step (b).

13. An Optical Time-Domain Reflectometer (OTDR) comprising:
a laser source operative, under the control of a processor via a pulse generator, for outputting a laser pulse to an optical fiber;
a receiver for receiving a backscatter signal generated by the optical fiber in response to the laser pulse output to the optical fiber, wherein the processor is programmed or configured to:
(a) determine from one or more values of samples of the received backscatter signal that at least one element of the receiver is operating in a saturated operating state;
(b) in response to the determining in step (a), control the receiver to decrease one or more values of samples of the received backscatter signal sampled after step (a), whereupon the at least one element of the receiver is operating in an unsaturated operating state;
(c) determine from one or more values of samples of the received backscatter signal sampled after step (b) that the at least one element of the receiver would not be operating in the saturated operating state if the values of samples of the backscatter signal were increased; and
(d) in response to step (c), control the receiver to increase one or more values of samples of the backscatter signal sampled after step (c).

14. The OTDR of claim 13, wherein:
elements of the receiver include a light detector and a transimpedance amplifier (TIA);
step (b) includes selecting a transresistance unit of the TIA having a lower gain; and
step (d) includes selecting a transresistance unit of the TIA having a higher gain.

15. The OTDR of claim 13, wherein:
the at least one element of the receiver including an avalanche photodiode;
step (b) includes decreasing a gain of the avalanche photodiode; and
step (d) includes increasing a gain of the avalanche photodiode.

16. The OTDR of claim 13, wherein:
elements of the receiver include a variable optical attenuator (VOA) and a light detector;
step (b) includes increasing a loss of the VOA; and
step (d) includes decreasing a loss of the VOA.

17. An Optical Time-Domain Reflectometer (OTDR) comprising:
means for outputting a laser pulse to an optical fiber;
means for receiving an optical backscatter signal generated by the optical fiber in response to the laser pulse output to the optical fiber;
means for determining from values of samples of the received optical backscatter signal that at least one element of the means for receiving is operating in a saturated state; and
means for controlling the means for receiving to decrease the values of the samples of the optical backscatter signal received by the means for determining such that the at least one element of the means for receiving is operating in an unsaturated state, wherein:
the means for determining determines from the values of the samples of the optical backscatter signal acquired after decreasing the values of the samples that the at least one element of the means for receiving would not be operating in a saturated state if the values of samples were increased; and
the means for controlling controls the means for receiving to increase the values of the samples of the optical backscatter signal acquired after the means for determining determines that the at least one element of the means for receiving would not be operating in a saturated state if the values of samples were increased.

18. The OTDR of claim 17, comprising at least one of the following:
the means for outputting the laser pulse to the optical fiber comprises a laser source;
the means for receiving comprises one of a transimpedance amplifier (TIA), a variable optical attenuator (VOA), and an avalanche photodiode;
the means for determining comprises a processor; and
the means for controlling comprises the processor.

19. The OTDR of claim 18, wherein the means for receiving further comprises one of the following:
a light detector for converting the received optical backscatter signal into a first electrical signal that the TIA converts to a second electrical signal, having an amplitude that is under the control of the processor, that an analog-to-digital converter (ADC) converts into the samples of the received optical backscatter signal, wherein the samples of the received optical backscatter signal are digitized samples;
a light detector for converting an optical signal output by the VOA in response to the received optical backscatter signal into an electrical signal that an analog-to-digital converter (ADC) converts into the samples of the received optical backscatter signal, wherein the samples of the received optical backscatter signal are digitized samples; and
an analog-to-digital converter (ADC), wherein the avalanche photodiode converts the received optical backscatter signal into an electrical signal that the ADC converts into the samples of the received optical backscatter signal, wherein the samples of the received optical backscatter signal are digitized samples.

20. The method of claim 1, wherein the samples in steps (b) and (e) are digital signals output to the processor by an analog-to-digital converter of the receiver of the OTDR.

21. The OTDR of claim 13, wherein the samples in steps (a) and (c) are digital signals output to the processor by an analog-to-digital converter of the receiver of the OTDR.

22. The OTDR of claim 17, wherein the at least one element of the means for receiving is an analog-to-digital converter (ADC).
